(19) United States
(12) Patent Application Publication
(10) Pub. No.: US 2025/0128254 A1
(43) Pub. Date: Apr. 24, 2025

(54) LYOPHILIZED BEAD PRE-EMBEDDING STRUCTURE, DIGITAL MICROFLUIDIC CHIP, AND PRE-EMBEDDING AND LIQUID INJECTION METHOD

(71) Applicant: JIANGSU LOGILET BIOTECH CO., LTD., Suzhou (CN)

(72) Inventors: Pei DU, Suzhou (CN); Yang SU, Suzhou (CN); Yan ZHANG, Suzhou (CN)

(21) Appl. No.: 18/836,068

(22) PCT Filed: Jul. 28, 2022
(86) PCT No.: PCT/CN2022/108637

§ 371 Date: Aug. 6, 2024

(30) Foreign Application Priority Data
Feb. 8, 2022 (CN) 202210117618.0

(51) Int. Cl. B01L 3/00

(52) U.S. Cl. CPC B01L 3/502715; B01L 3/5023; B01L 2200/0647; B01L 2200/16; B01L 2300/044; B01L 2300/0672; B01L 2300/069; B01L 2400/0427

(57) ABSTRACT

The present application provides a lyophilized bead pre-embedding structure, a digital microfluidic chip, and a pre-embedding and liquid injection method. The present application realizes normal-temperature transportation of the digital microfluidic chip, saves the transportation cost, and improves the stability and reliability of chip reagent pre-embedding.

### TECHNICAL FIELD

The present application belongs to the technical field of microfluidic chips, and relates to a lyophilized bead pre-embedding structure, a digital microfluidic chip, and a pre-embedding and liquid injection method.

### BACKGROUND ART

Test methods, such as qPCR, LAMP and immunoluminescence, are widely used in the fields of biology, medicine, etc. for determining whether a sample carries a gene associated with a genetic disease, diagnosing infectious diseases, detecting gene duplication, taking a paternity test, etc. In a traditional detection apparatus, it is usually necessary to use a pipette to draw up a certain amount of a liquid sample, align the pipette with an injection port, and inject the entire liquid into a reaction chamber. Using the pipette for sample injection results in increased use cost and high dependency on the pipette.

Digital microfluidic chips, based on the principle of electrowetting technology, regulate solid-liquid surface energy by electric potential and use unbalanced surface energy to drive liquid movement, so as to achieve precise micro-liquid control. A digital microfluidic chip mainly includes a transparent conductive cover (e.g., ITO glass), an electrode array that includes a hydrophobic layer and a dielectric layer on a surface thereof, etc., and a clearance cavity for droplet movement is provided between the transparent conductive cover and the electrode array. The digital microfluidic chips can integrate operation procedures, such as sampling, dilution, reagent addition, reaction, separation and testing, that are usually required in the fields of biology, chemistry, medicine, etc., can allow for less sample consumption than traditional means of manipulation while have the advantages of high sensitivity, high accuracy, high throughput and high integration, and can quickly realize automatic integration of an entire process of biochemical reaction at a low cost. Moreover, the entire process of reaction is fully closed without cross contamination, and can be operated with one button, which greatly frees an operator's hands.

CN 214716735 U discloses a reagent pre-embedding and sample injection device and a digital microfluidic chip including same. A testing reagent is stored in a sealed manner and pre-embedded on a chip, and when in use, a chip device is depressed by a sample injection structure and apparatus to achieve automatic sample injection. However, the above method is only applicable to liquid reagents. During PCR reactions, the transportation of reagents, such as primers (upstream and downstream primers), Taq polymerase, dNTPs, Mg2+, buffer solutions and other liquid reagents, required for amplification needs to be stored at −20° C. to ensure the properties of the reagents. If the amplification reagents are packaged and pre-embedded in digital microfluidic chips in the form of liquid, the difficulty of transporting the digital microfluidic chips will be increased, resulting in a high cost and difficult quality control of the digital microfluidic chips.

In the traditional technology, fully manually operated reaction plates (such as 96-well plates and 384-well plates), or continuous microfluidic devices and microdroplet microfluidics with syringe pumps, etc. are used. The reaction plates have poor expansibility and usually have 96 wells or 384 wells, so that it is impossible to add new reaction groups midway once a reaction is started; and full manual operations are required, which is time-consuming and labor-intensive. The operations of the microfluidic devices and the microdroplet microfluidics rely heavily on the syringe pump, resulting in a high cost. Directly pre-embedding liquid amplification reagents pose high requirements on transportation conditions, resulting in high costs and difficult quality control.

Thus, how to provide a reagent pre-embedding and sample injection device and method that can be applied to digital microfluidic chips has become an urgent problem to be solved.

### SUMMARY

To address the defects in the prior art, the present application provides a lyophilized bead pre-embedding structure, a digital microfluidic chip, and a pre-embedding and liquid injection method. By means of allowing reagents required for amplification to be lyophilized and then packaged and pre-embedded and dissolving the pre-embedded structure during use, and taking the uniqueness and advantages of the digital microfluidic chip, the automatic sample injection during use of the chip is achieved.

According to the present application, the following technical solutions are achieved.

In a first aspect, the present application provides a lyophilized bead pre-embedding structure, including a lyophilization bubble cap and a sample injection holder, wherein a sample injection cavity is formed in the sample injection holder; a liquid injection column is provided in the sample injection cavity, a lyophilized bead placement cavity is formed in the liquid injection column, and a lyophilized bead is provided in the lyophilized bead placement cavity; and the lyophilization bubble cap is embedded into the sample injection cavity, a diluent groove filled with a diluent is formed in the lyophilization bubble cap, the liquid injection column matches and is nested in the diluent groove, and the diluent groove is filled with the diluent and then packaged with a packaging film; and the lyophilization bubble cap is pressed into the sample injection cavity, the liquid injection column punctures the packaging film, and the diluent enters the lyophilized bead placement cavity to dissolve the lyophilized bead.

According to the present application, the lyophilized bead is pre-embedded in the lyophilized bead placement cavity, and then the lyophilization bubble cap filled with the diluent is embedded into the lyophilized bead placement cavity to complete pre-embedding of the lyophilized bead; and when liquid injection is needed, the lyophilization bubble cap is depressed to puncture the packaging film by means of the liquid injection column, such that the diluent contacts with and dissolves the lyophilized bead, and liquid after the dissolving enters the clearance cavity of the digital microfluidic chip for use. In this way, it is possible to realize room-temperature transportation of the digital microfluidic chip, save transportation costs, and improve the stability and reliability of chip reagent pre-embedding.

It should be noted that no specific requirement and no special limit are imposed on the structures of the diluent groove and the liquid injection column in the present application, and can be reasonably set by those skilled in the art according to design requirements, as long as the liquid injection column matches and is nested in the diluent groove to avoid formation of a gap that causes leakage of the diluent.

It should be noted that no specific requirement and no special limit are imposed on the position of the liquid injection column in the present application, for example, the liquid injection column is located at the center of the sample injection cavity. In addition, in the present application, the lyophilized bead may be reasonably sized according to the design, for example, the lyophilized bead has a diameter of 2-4 mm.

As a preferred technical solution of the present application, a sealing protrusion that matches and is nested in the lyophilized bead placement cavity is provided in the diluent groove, and after the lyophilization bubble cap is pressed into the sample injection cavity, the sealing protrusion is pressed into the lyophilized bead placement cavity.

According to the present application, the sealing protrusion is provided, and during the press-in process of the lyophilization bubble cap, the sealing protrusion fills in the lyophilized bead placement cavity to form a male-female fit relationship, so that the liquid can only flow to the position of the lyophilized bead after being squeezed and is then pressed into the clearance cavity of the digital microfluidic chip for use.

It should be noted that no specific requirement and no special limit are imposed on the structures of the sealing protrusion and the lyophilized bead placement cavity in the present application, and can be reasonably set by those skilled in the art according to design requirements to ensure that the sealing protrusion is embedded in and fills up the lyophilized bead placement cavity, thus further preventing the diluent and the liquid after the dissolving of the lyophilized bead from flowing out.

As a preferred technical solution of the present application, a lyophilized bead holder is provided in the lyophilized bead placement cavity, and the lyophilized bead is placed on the lyophilized bead holder.

In an embodiment of the present application, the lyophilized bead holder and the sample injection holder are of an integrated structure, or the lyophilized bead holder is arranged on the sample injection holder, for example, bonded or detachably arranged on the sample injection holder.

As a preferred technical solution of the present application, a positioning guide structure is provided on wall surfaces of the lyophilization bubble cap and the sample injection holder in contact with each other.

According to the present application, the positioning guide structure is provided to improve the tightness of bonding between the lyophilization bubble cap and the sample injection holder during the pre-embedding process and the liquid injection process.

Preferably, the positioning guide structure includes a guide slot and a guide slide rail respectively provided on the lyophilization bubble cap and the sample injection holder.

It should be noted that no specific requirement and no special limit are imposed on the positions of the guide slot and the guide slide rail in the present application, as long as the guide slot and the guide slide rail are used cooperatively to achieve the limiting and guiding function. For example, the guide slot is provided on an outer wall of the lyophilization bubble cap, and the guide slide rail is provided on an inner wall of the sample injection holder; or, the guide slot is provided on the inner wall of the sample injection holder, and the guide slide rail is provided on the outer wall of the lyophilization bubble cap.

Preferably, an outer wall of the lyophilization bubble cap is of a structure that is tapered in a press-in direction.

According to the present application, the outer wall of the lyophilization bubble cap is designed to be of a structure that is tapered in size, such that the lyophilization bubble cap becomes greater in external size during the press-in process and is pressed into the sample injection cavity to form an interference fit, thus preventing the lyophilization bubble cap from popping out after being pressed in.

As a preferred technical solution of the present application, a venting structure is provided on the lyophilization bubble cap and the sample injection holder.

Preferably, the venting structure includes a venting channel formed in an inner wall of the sample injection cavity.

Preferably, the venting structure includes a vent formed in the lyophilization bubble cap.

Preferably, the venting structure includes a venting notch formed on an edge of the lyophilization bubble cap.

In a second aspect, the present application provides a digital microfluidic chip provided with at least one lyophilized bead pre-embedding structure as described in the first aspect, the lyophilized bead placement cavity being connected to a clearance cavity of the digital microfluidic chip.

As a preferred technical solution of the present application, the digital microfluidic chip includes a substrate provided with an electrode array. A dielectric layer and a transparent conductive layer are provided on the substrate, and a clearance cavity is formed between the dielectric layer and the transparent conductive layer.

Preferably, a clearance adhesive is provided at bonding edges of the dielectric layer and the transparent conductive layer, and the dielectric layer and the transparent conductive layer are spaced apart by the clearance adhesive to form the clearance cavity.

Preferably, a hydrophobic layer is provided on a side surface of the dielectric layer close to the clearance cavity.

Preferably, a hydrophobic layer is provided on a side surface of the transparent conductive layer close to the clearance cavity.

As a preferred technical solution of the present application, at least two lyophilized bead pre-embedding structures are independently connected to the clearance cavity of the digital microfluidic chip.

Preferably, the lyophilized bead pre-embedding structures are arranged in a linear array at an edge of the digital microfluidic chip.

As a preferred technical solution of the present application, the lyophilized bead placement cavity is connected to the clearance cavity of the digital microfluidic chip by means of a liquid injection tube.

It should be noted that no specific requirement and no special limit are imposed on the structure of the liquid injection tube in the present application. For example, the liquid injection tube is a straight tube, a bent tube, a spiral tube or the like, and the cross-section of the liquid injection tube includes but is not limited to a circular shape and a rectangular shape, as long as the lyophilized bead placement cavity can be in communication with the clearance cavity.

Preferably, the liquid injection tube is arranged obliquely.

In a third aspect, the present application provides a lyophilized bead pre-embedding and liquid injection method for a digital microfluidic chip as described in the second aspect, the pre-embedding and liquid injection method including:

placing a lyophilized bead in the lyophilized bead placement cavity, filling the diluent groove of the lyophilization bubble cap with a diluent and packaging the diluent groove with a packaging film, and embedding the lyophilization bubble cap into the lyophilized bead placement cavity to complete pre-embedding of the lyophilized bead;

during liquid injection, depressing the lyophilization bubble cap to enable the liquid injection column to puncture the packaging film, such that the diluent enters the lyophilized bead placement cavity to dissolve the lyophilized bead, and liquid after the dissolving enters the clearance cavity of the digital microfluidic chip to complete the liquid injection.

Compared with the prior art, the present application has the beneficial effects as follows.

According to the present application, the lyophilized bead is pre-embedded in the lyophilized bead placement cavity, and then the lyophilization bubble cap filled with the diluent is embedded into the lyophilized bead placement cavity to complete pre-embedding of the lyophilized bead; and when liquid injection is needed, the lyophilization bubble cap is depressed to puncture the packaging film by means of the liquid injection column, such that the diluent contacts with and dissolves the lyophilized bead, and liquid after the dissolving enters the clearance cavity of the digital microfluidic chip for use. In this way, it is possible to realize room-temperature transportation of the digital microfluidic chip, save transportation costs, and improve the stability and reliability of chip reagent pre-embedding.

### BRIEF DESCRIPTION OF THE DRAWINGS

FIG. 1 is a schematic exploded view of a lyophilized bead pre-embedding structure according to a specific embodiment of the present application;

FIG. 2 is a schematic diagram of a structure of a lyophilization bubble cap according to a specific embodiment of the present application;

FIG. 3 is a schematic diagram of a venting structure according to a specific embodiment of the present application;

FIG. 4 is a schematic diagram of another venting structure according to a specific embodiment of the present application;

FIG. 5 is a schematic diagram of an external structure of a digital microfluidic chip according to a specific embodiment of the present application;

FIG. 6 is a schematic diagram of another external structure of the digital microfluidic chip according to a specific embodiment of the present application;

FIG. 7 is a schematic diagram of the cross-sectional structure of the digital microfluidic chip according to a specific embodiment of the present application;

FIG. 8 is a schematic diagram of a structure of a clearance cavity of a digital microfluidic chip according to a specific embodiment of the present application;

FIG. 9 is a schematic diagram of an electrode position of the digital microfluidic chip according to a specific embodiment of the present application; and

FIG. 10 is a schematic flowchart of pre-embedding and liquid injection according to a specific embodiment of the present application, with directions of pressure represented by arrows.

In the figures: 1-sample injection holder; 2-lyophilization bubble cap; 3-liquid injection column; 4-lyophilized bead holder; 5-lyophilized bead; 6-liquid injection tube; 7- diluent groove; 8-sealing protrusion; 9-guide slide rail; 10-venting channel; 11-vent; 12- digital microfluidic chip; 13-lyophilized bead pre-embedding structure; 14-clearance cavity; 15-substrate; 16-electrode array; 17-dielectric layer; 18-transparent conductive layer; 19- hydrophobic layer; 20-clearance adhesive.

### DETAILED DESCRIPTION OF EMBODIMENTS

It should be understood that, in the description of the present application, the orientation or position relationships indicated by the terms such as “center”, “longitudinal”, “transverse”, “up”, “down”, “front”, “rear”, “left”, “right”, “vertical”, “horizontal”, “top”, “bottom”, “inside” and “outside” are based on the orientation or position relationships shown in the drawings and are merely for ease of description of the present application and for simplicity of the description, rather than indicating or implying that the device or element referred to must have a particular orientation or be constructed and operated in a particular orientation, and thus cannot be construed as a limitation on the present application.

It should be noted that in the description of the present application, unless otherwise explicitly specified and defined, the terms “arrangement”, “connecting” and “connection” should be understood in a broad sense, for example, they may be a fixed connection, a detachable connection, or an integrated connection; or may be a mechanical connection or an electrical connection; or may be a direct connection, an indirect connection by means of an intermediate medium, or internal communication between two elements. For those of ordinary skill in the art, the specific meaning of the terms mentioned above in the present application can be construed according to specific circumstances.

The technical solution of the present application will be further described below with reference to the specific embodiments.

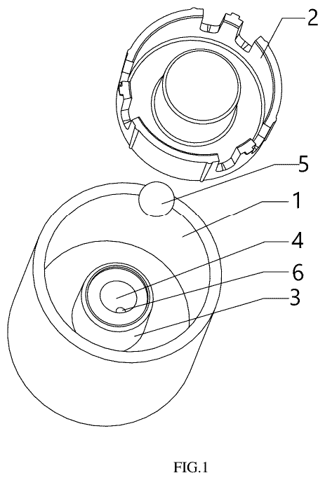

In a specific embodiment, the present application provides a lyophilized bead pre-embedding structure. As shown in FIG. 1, the lyophilized bead pre-embedding structure includes a lyophilization bubble cap 2 and a sample injection holder 1. A sample injection cavity is formed in the sample injection holder 1. A liquid injection column 3 is provided in the sample injection cavity, a lyophilized bead placement cavity is formed in the liquid injection column 3, and a lyophilized bead 5 is provided in the lyophilized bead placement cavity. The lyophilization bubble cap 2 is embedded into the sample injection cavity, a diluent groove 7 filled with a diluent is formed in the lyophilization bubble cap 2, the liquid injection column 3 matches and is nested in the diluent groove 7, and the diluent groove 7 is filled with the diluent and then packaged with a packaging film. The lyophilization bubble cap 2 is pressed into the sample injection cavity, the liquid injection column 3 punctures the packaging film, and the diluent enters the lyophilized bead placement cavity to dissolve the lyophilized bead 5.

According to the present application, the lyophilized bead 5 is pre-embedded in the lyophilized bead placement cavity, and the lyophilization bubble cap 2 filled with the diluent is embedded into the lyophilized bead placement cavity to complete pre-embedding of the lyophilized bead 5. When liquid injection is needed, the lyophilization bubble cap 2 is depressed to puncture the packaging film by means of the liquid injection column 3, such that the diluent contacts with and dissolves the lyophilized bead 5, and liquid after the dissolving enters the clearance cavity of the digital microfluidic chip for use. In this way, it is possible to realize room-temperature transportation of the digital microfluidic chip, save transportation costs, and improve the stability and reliability of chip reagent pre-embedding.

Optionally, the structures of the diluent groove 7 and the liquid injection column 3 are not specifically limited in the embodiments of the present application, as long as the liquid injection column 3 matches and is nested in the diluent groove 7, thus avoiding formation of a gap that causes leakage of the diluent. For example, the diluent groove and the liquid injection column are both cylindrical. Further, no specific requirement and no special limit are imposed on the position of the liquid injection column 3 in the embodiments of the present application. For example, the liquid injection column 3 is located at the center of the sample injection cavity, and the lyophilized bead 5 has a diameter of 2-4 mm.

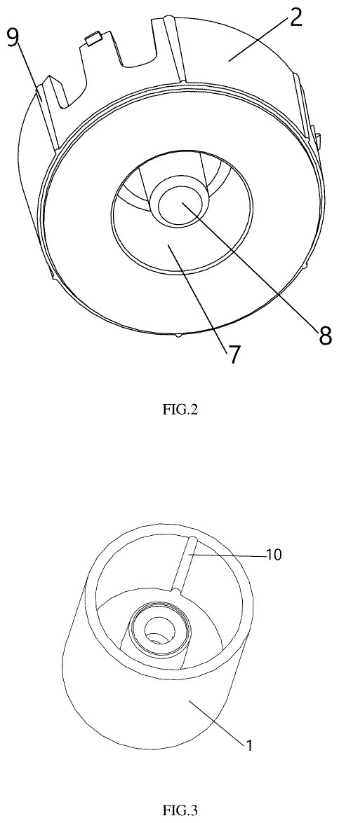

Specifically, as shown in FIG. 2, a sealing protrusion 8 that matches and is nested in the lyophilized bead placement cavity is provided in the diluent groove 7, and after the lyophilization bubble cap 2 is pressed into the sample injection cavity, the sealing protrusion 8 is pressed into the lyophilized bead placement cavity. According to the present application, the sealing protrusion 8 is provided, and during the press-in process of the lyophilization bubble cap 2, the sealing protrusion 8 fills in the lyophilized bead placement cavity to form a male-female fit relationship, so that the liquid can only flow to the position of the lyophilized bead 5 after being squeezed and is then pressed into the clearance cavity of the digital microfluidic chip for use. The sealing protrusion 8 is embedded in and fills up the lyophilized bead placement cavity, thus further preventing the diluent and the liquid after the dissolving of the lyophilized bead 5 from flowing out.

Specifically, a lyophilized bead holder 4 is provided in the lyophilized bead placement cavity, and the lyophilized bead 5 is placed on the lyophilized bead holder 4. Optionally, the lyophilized bead holder 4 and the sample injection holder 1 are of an integrated structure, or the lyophilized bead holder 4 is arranged on the sample injection holder 1, for example, bonded or detachably arranged on the sample injection holder 1.

Specifically, a positioning guide structure is provided on wall surfaces of the lyophilization bubble cap 2 and the sample injection holder 1 in contact with each other. Further, the positioning guide structure includes a guide slot and a guide slide rail respectively provided on the lyophilization bubble cap 2 and the sample injection holder 1. Optionally, the guide slot is provided on an outer wall of the lyophilization bubble cap, and as shown in FIG. 2, the guide slide rail 9 is provided on an inner wall of the sample injection holder 1; or, the guide slot is provided on the inner wall of the sample injection holder, and the guide slide rail is provided on the outer wall of the lyophilization bubble cap. According to the present application, the positioning guide structure is provided to improve the tightness of bonding between the lyophilization bubble cap 2 and the sample injection holder 1 during the pre-embedding process and the liquid injection process.

Specifically, the outer wall of the lyophilization bubble cap 2 is of a structure that is tapered in a press-in direction. According to the present application, the outer wall of the lyophilization bubble cap 2 is designed to be of a structure that is tapered in size, such that the lyophilization bubble cap 2 becomes greater in external size during the press-in process and is pressed into the sample injection cavity to form an interference fit, thus preventing the lyophilization bubble cap 2 from popping out after being pressed in.

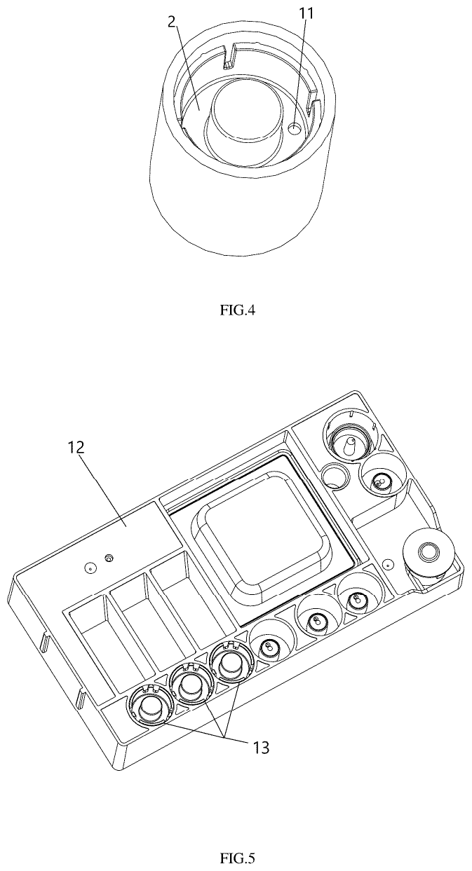

Specifically, a venting structure is provided on the lyophilization bubble cap 2 and the sample injection holder 1. Optionally, as shown in FIG. 3, the venting structure includes a venting channel 10 formed in an inner wall of the sample injection cavity; or, as shown in FIG. 4, the venting structure includes a vent 11 formed in the lyophilization bubble cap 2; or, the venting structure includes a venting notch formed on an edge of the lyophilization bubble cap 2.

In another specific embodiment, the present application provides a digital microfluidic chip 12. As shown in FIGS. 5, 6 and 7, the digital microfluidic chip 12 is provided with at least one lyophilized bead pre-embedding structure 13 as described in any embodiment of the present application, the lyophilized bead placement cavity being connected to the clearance cavity of the digital microfluidic chip 12.

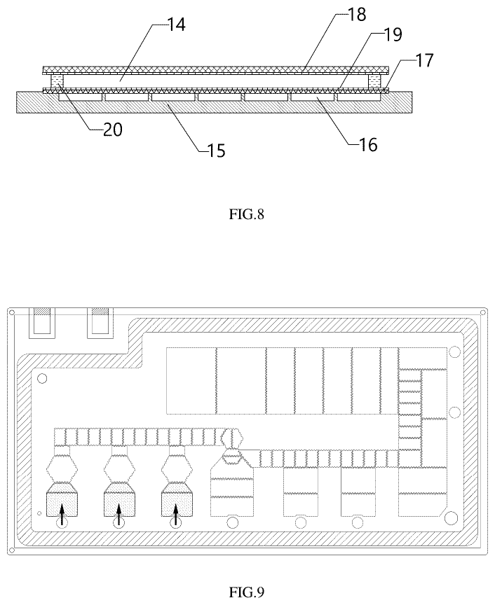

As shown in FIG. 8, the digital microfluidic chip 12 includes a substrate 15 provided with an electrode array 16. The arrangement of electrodes on the substrate is as shown in FIG. 9, a dielectric layer 17 and a transparent conductive layer 18 are provided on the substrate 15, and a clearance cavity 14 is formed between the dielectric layer 17 and the transparent conductive layer 18. Further, a clearance adhesive 20 is provided at bonding edges of the dielectric layer 17 and the transparent conductive layer 18, and the dielectric layer 17 and the transparent conductive layer 18 are spaced apart by the clearance adhesive 20 to form the clearance cavity 14. Still further, a hydrophobic layer 19 is provided on a side surface of the dielectric layer 17 close to the clearance cavity 14. A hydrophobic layer 19 is provided on a side surface of the transparent conductive layer 18 close to the clearance cavity 14.

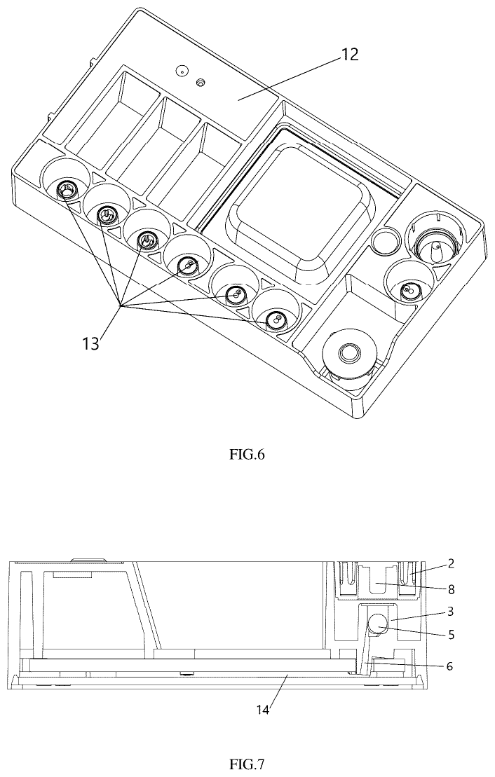

Specifically, at least two lyophilized bead pre-embedding structures 13 are independently connected to the clearance cavity 14 of the digital microfluidic chip 12. Still as shown in FIG. 6, the lyophilized bead pre-embedding structures 13 are arranged in a linear array at an edge of the digital microfluidic chip 12.

Specifically, the lyophilized bead placement cavity is connected to the clearance cavity 14 of the digital microfluidic chip 12 by means of a liquid injection tube 6. Further, the liquid injection tube 6 is arranged obliquely. Optionally, the liquid injection tube 6 is a straight tube, a bent tube, a spiral tube or the like, and the cross-section of the liquid injection tube 6 includes but is not limited to a circular shape and a rectangular shape, as long as the lyophilized bead placement cavity can be in communication with the clearance cavity 14.

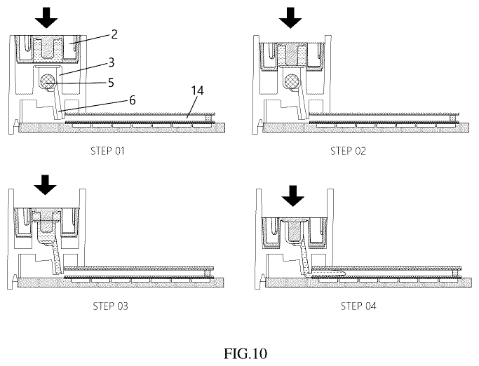

In another specific embodiment, the present application provides a lyophilized bead 5 pre-embedding and liquid injection method for a digital microfluidic chip 12 provided in any embodiment of the present application. As shown in FIG. 10, the pre-embedding and liquid injection method includes:
placing the lyophilized bead 5 in the lyophilized bead placement cavity, filling the diluent groove of the lyophilization bubble cap 2 with a diluent and packaging the diluent groove with a packaging film, and embedding the lyophilization bubble cap 2 into the lyophilized bead placement cavity to complete pre-embedding of the lyophilized bead 5; and
during liquid injection, depressing the lyophilization bubble cap 2 to enable the liquid injection column 3 to puncture the packaging film, such that the diluent enters the lyophilized bead placement cavity to dissolve the lyophilized bead 5, and the liquid after the dissolving enters the clearance cavity 14 of the digital microfluidic chip 12 by means of the liquid injection tube 6 to complete the liquid injection.

In a specific embodiment, according to the present application, the lyophilized bead 5 is pre-embedded in the lyophilized bead placement cavity, and the lyophilization bubble cap 2 filled with the diluent is embedded into the lyophilized bead placement cavity to complete pre-embedding of the lyophilized bead 5; and when liquid injection is needed, the lyophilization bubble cap 2 is depressed to puncture the packaging film by means of the liquid injection column 3, such that the diluent contacts with and dissolves the lyophilized bead 5, and the liquid after the dissolving enters the clearance cavity of the digital microfluidic chip for use. In this way, it is possible to realize room-temperature transportation of the digital microfluidic chip, save transportation costs, and improve the stability and reliability of chip reagent pre-embedding.

The applicant gives notice that the foregoing descriptions are only specific embodiments of the present application, but are not intended to limit the scope of protection of the present application. Those skilled in the art shall understand that any variation or replacement readily conceived by those skilled in the art within the technical scope disclosed in the present application shall fall within the scope of protection of the present application.

1-11. (canceled)

12. A lyophilized bead pre-embedding structure, comprising a lyophilization bubble cap and a sample injection holder, wherein a sample injection cavity is formed in the sample injection holder;
a liquid injection column is provided in the sample injection cavity, a lyophilized bead placement cavity is formed in the liquid injection column, and a lyophilized bead is provided in the lyophilized bead placement cavity; and
the lyophilization bubble cap is embedded into the sample injection cavity and located above the liquid injection column, a diluent groove filled with a diluent is formed in the lyophilization bubble cap, the liquid injection column is configured to match and be nested in the diluent groove, the diluent groove is filled with the diluent and then packaged with a packaging film, and the packaging film is puncturable by the liquid injection column.

13. The lyophilized bead pre-embedding structure according to claim 12, wherein a sealing protrusion configured to be pressed into the lyophilized bead placement cavity is provided in the diluent groove.

14. The lyophilized bead pre-embedding structure according to claim 12, wherein a lyophilized bead holder is provided in the lyophilized bead placement cavity, and the lyophilized bead is placed on the lyophilized bead holder.

15. The lyophilized bead pre-embedding structure according to claim 12, wherein a positioning guide structure is provided on wall surfaces of the lyophilization bubble cap and the sample injection holder in contact with each other.

16. The lyophilized bead pre-embedding structure according to claim 15, wherein the positioning guide structure comprises a guide slot provided on one of the lyophilization bubble cap and the sample injection holder and a guide slide rail provided on the other one of the lyophilization bubble cap and the sample injection holder.

17. The lyophilized bead pre-embedding structure according to claim 15, wherein an outer wall of the lyophilization bubble cap is of a structure that is tapered in a press-in direction.

18. The lyophilized bead pre-embedding structure according to claim 12, wherein a venting structure is provided on the lyophilization bubble cap and/or the sample injection holder.

19. The lyophilized bead pre-embedding structure according to claim 18, wherein the venting structure comprises a venting channel formed in an inner wall of the sample injection cavity;
wherein the venting structure comprises a vent formed in the lyophilization bubble cap; and/or
wherein the venting structure comprises a venting notch formed on an edge of the lyophilization bubble cap.

20. A digital microfluidic chip, comprising at least one lyophilized bead pre-embedding structure according to claim 12, wherein the lyophilized bead placement cavity is connected to a clearance cavity of the digital microfluidic chip.

21. The digital microfluidic chip according to claim 20, comprising a substrate provided with an electrode array, wherein a dielectric layer and a transparent conductive layer are provided on the substrate, and the clearance cavity is formed between the dielectric layer and the transparent conductive layer.

22. The digital microfluidic chip according to claim 21, wherein a clearance adhesive is provided at bonding edges of the dielectric layer and the transparent conductive layer, and the dielectric layer and the transparent conductive layer are spaced apart by the clearance adhesive to form the clearance cavity.

23. The digital microfluidic chip according to claim 21, wherein a hydrophobic layer is provided on a side surface of the dielectric layer close to the clearance cavity.

24. The digital microfluidic chip according to claim 21, wherein a hydrophobic layer is provided on a side surface of the transparent conductive layer close to the clearance cavity.

25. The digital microfluidic chip according to claim 20, comprising at least two lyophilized bead pre-embedding structures independently connected to the clearance cavity of the digital microfluidic chip.

26. The digital microfluidic chip according to claim 25, wherein the lyophilized bead pre-embedding structures being arranged in a linear array at an edge of the digital microfluidic chip.

27. The digital microfluidic chip according to claim 17, wherein the lyophilized bead placement cavity is connected to the clearance cavity of the digital microfluidic chip by means of a liquid injection tube.

28. The digital microfluidic chip according to claim 27, wherein the liquid injection tube is arranged obliquely.

29. A pre-embedding and liquid injection method using a lyophilized bead pre-embedding structure configured according to claim 12, the pre-embedding and liquid injection method comprising lyophilized bead pre-embedding and liquid injection, wherein the lyophilized bead pre-embedding comprises:
placing a lyophilized bead in a lyophilized bead placement cavity;
filling a diluent groove of a lyophilization bubble cap with a diluent and packaging the diluent groove with a packaging film; and
embedding the lyophilization bubble cap into a sample injection cavity of a sample injection holder, with the lyophilization bubble cap being located above the sample injection cavity; and
the liquid injection comprises:
depressing the lyophilization bubble cap to enable a liquid injection column in the sample injection holder to puncture the packaging film, such that the diluent enters the lyophilized bead placement cavity to dissolve the lyophilized bead.

30. A lyophilized bead pre-embedding and liquid injection method for a digital microfluidic chip according to claim 20, the lyophilized bead pre-embedding and liquid injection method comprising:
placing a lyophilized bead in the lyophilized bead placement cavity, filling the diluent groove of the lyophilization bubble cap with a diluent and packaging the diluent groove with a packaging film, and embedding the lyophilization bubble cap into a sample injection cavity of a sample injection holder to complete pre-embedding of the lyophilized bead; and
during liquid injection, depressing the lyophilization bubble cap to enable the liquid injection column to puncture the packaging film, such that the diluent enters the lyophilized bead placement cavity to dissolve the lyophilized bead, and liquid after the dissolving enters the clearance cavity of the digital microfluidic chip to complete the liquid injection.
